(19) United States
(12) Patent Application Publication
(10) Pub. No.: US 2018/0059482 A1
(43) Pub. Date: Mar. 1, 2018

(54) Light Diffusers for Backlit Displays

(71) Applicant: Apple Inc., Cupertino, CA (US)

(72) Inventors: Xiangtong Li, Fremont, CA (US); Jun Qi, Cupertino, CA (US); Mingxia Gu, San Jose, CA (US); Rong Liu, Sunnyvale, CA (US); Victor H. Yin, Cupertino, CA (US); Yu P. Sun, San Jose, CA (US)

(21) Appl. No.: 15/356,084

(22) Filed: Nov. 18, 2016

Related U.S. Application Data
(60) Provisional application No. 62/381,313, filed on Aug. 30, 2016.

(51) Int. Cl. G02F 1/1335; F21V 3/04; F21V 9/16; F21V 9/00; F21V 7/00; F21V 13/12

(52) U.S. Cl. CPC G02F 1/133606; F21V 3/0472; F21V 9/16; F21V 9/00; F21V 7/00; F21Y 2115/10; F21V 13/12; G02F 1/133603; G02F 1/133605; G02F 1/133509; F21V 3/049

(57) ABSTRACT

An array of pixels in a display may be illuminated by a backlight having an array of light-emitting diodes in an array of respective light-emitting diode cells. A cavity reflector in each cell may help distribute blue light emitted from the light-emitting diode of that cell toward edges of the cell. Optical films in the backlight may include a photoluminescent layer such as a phosphor layer that converts blue light from the light-emitting diode array into white light and may include a dichroic filter for reflecting white light away from the diode array towards the pixel array. A light diffuser layer for the backlight may have printed white ink pads, recesses filled with a high index of refraction material, protrusions for light scattering, light-scattering particles, thin-film interference filters, partially reflective mirrors, and other structures for diffusing the light from the light-emitting diodes.

This application claims the benefit of provisional patent application No. 62/381,313, filed Aug. 30, 2016, which is hereby incorporated by reference herein in its entirety.

### BACKGROUND

This relates generally to displays, and more particularly, to backlit displays.

Electronic devices often include displays. For example, computers and cellular telephones are sometimes provided with backlit liquid crystal displays. Edge-lit backlight units have light-emitting diodes that emit light into an edge surface of a light guide plate. The light guide plate then distributes the emitted light laterally across the display to serve as backlight illumination. Direct-lit backlight units have arrays of light-emitting diodes that emit light vertically through the display.

Direct-lit backlights may have locally dimmable light-emitting diodes that allow dynamic range to be enhanced. If care is not taken, however, a direct-lit backlight may be bulky or may produce non-uniform backlight illumination.

It would therefore be desirable to be able to provide improved backlighting arrangements for electronic device displays.

### SUMMARY

A display may be provided with an array of pixels for displaying images for a viewer. The array of pixels may be provided with backlight illumination from a direct-lit backlight. The backlight may have an array of light-emitting diodes in an array of respective light-emitting diode cells. Each light-emitting diode cell may have a center at which a light-emitting diode is located and edges. A cavity reflector in each cell may help distribute blue light emitted from a light-emitting diode at the center of that cell toward the edges of the cell and outwards through the array of pixels.

The backlight may include optical films. The optical films may include a photoluminescent layer such as a white phosphor layer that converts blue light from the light-emitting diode array into white light and may include a dichroic filter for reflecting white light away from the diode array towards the pixel array.

A light diffuser layer for the backlight may have printed white ink pads, recesses filled with a material having an elevated index of refraction, protrusions for light scattering, light-scattering particles, thin-film interference filters, partially reflective mirrors, and other structures for diffusing and recycling the light from the light-emitting diodes. The light diffuser may preferentially reflect on-axis light and light emitted from the light-emitting diode towards portions of the light diffuser at the center of each cell to help reduce hotspots in the diffused light.

### BRIEF DESCRIPTION OF THE DRAWINGS

FIG. 1 is a diagram of an illustrative electronic device having a display in accordance with an embodiment.

FIG. 2 is a cross-sectional side view of an illustrative display in accordance with an embodiment.

FIG. 3 is a top view of an illustrative light-emitting diode array for a direct-lit backlight unit in accordance with an embodiment.

FIG. 4 is a cross-sectional side view of an illustrative light-emitting diode in accordance with an embodiment.

FIG. 5 is a cross-sectional side view of illustrative light-emitting diode in a cavity reflector in accordance with an embodiment.

FIG. 6 is a cross-sectional side view of a light-emitting diode and associated diffuser layer showing how light may be emitted from the light-emitting diode at various angles in accordance with an embodiment.

FIG. 7 is a graph showing how the intensity of light from a light-emitting diode in a direct-lit backlight may vary as a function of light emission angle in accordance with an embodiment.

FIG. 8 is a cross-sectional side view of an illustrative light diffuser with a patterned light-diffusing coating forming an array of pads in accordance with an embodiment.

FIG. 9 a cross-sectional side view of an illustrative light diffuser with a light-diffusing coating that has been patterned to form light-diffusing pads of varying density that are concentrated over light-emitting diodes in accordance with an embodiment.

FIG. 10 is a cross-sectional side view of an illustrative light diffuser with recesses such as pyramidal or conical recesses filled with transparent material in accordance with an embodiment.

FIG. 11 is a cross-sectional side view of an illustrative light diffuser having recesses such as pyramidal or conical recesses filled with transparent material and embedded reflectivity enhancing particles in accordance with an embodiment.

FIG. 12 is a cross-sectional side view of an illustrative light diffuser with recesses having a graded density in accordance with an embodiment.

FIG. 13 is a cross-sectional side view of an illustrative light diffuser having recesses and protrusions in accordance with an embodiment.

FIG. 14 is a cross-sectional side view of an illustrative light diffuser having patterned coating structures that homogenize light such as white ink pads and having protrusions for diffusing light in accordance with an embodiment.

FIG. 15 is a cross-sectional side view of an illustrative light diffuser with a partially reflective layer and a light-diffusing coating in accordance with an embodiment.

FIG. 16 is a cross-sectional side view of an illustrative light diffuser with a graded concentration of light-scattering structures of the type that may be concentrated over each light-emitting diode in an array of light-emitting diodes in accordance with an embodiment.

FIG. 17 is a cross-sectional side view of an illustrative light diffuser with a thin-film interference filter formed from a stack of thin-film dielectric layers in accordance with an embodiment.

FIG. 18 is a graph showing how the light diffuser of FIG. 17 mays exhibit an angularly varying light transmittance at a wavelength associated with light emitted by a light-emitting diode in a direct-lit backlight unit in accordance with an embodiment.

### DETAILED DESCRIPTION

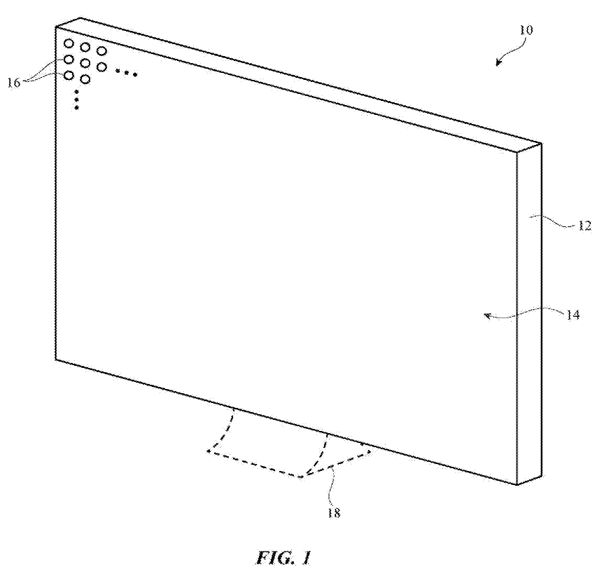

Electronic devices may be provided with backlit displays. The backlit displays may include liquid crystal display modules or other display structures that are backlit by light from a direct-lit backlight. A perspective view of an illustrative electronic device of the type that may be provided with a display having a direct-lit backlight is shown in FIG. 1. Electronic device 10 of FIG. 1 may be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment.

As shown in FIG. 1, device 10 may have a display such as display 14. Display 14 may be mounted in housing 12. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.).

Housing 12 may have a stand such as optional stand 18, may have multiple parts (e.g., housing portions that move relative to each other to form a laptop computer or other device with movable parts), may have the shape of a cellular telephone or tablet computer (e.g., in arrangements in which stand 18 is omitted), and/or may have other suitable configurations. The arrangement for housing 12 that is shown in FIG. 1 is illustrative.

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures.

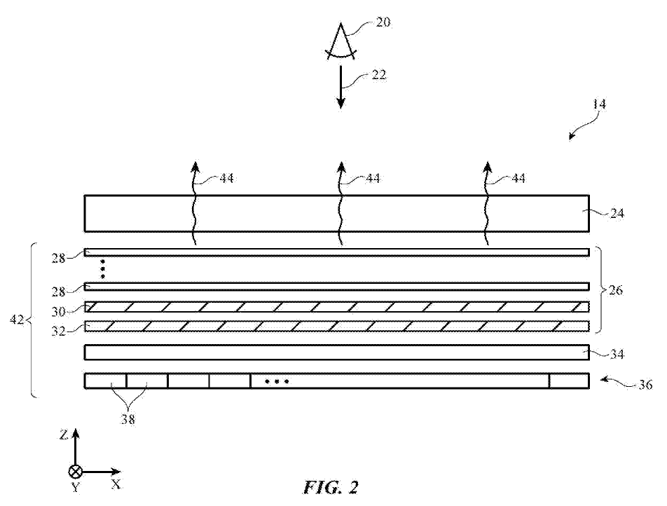

Display 14 may include an array of pixels 16 formed from liquid crystal display (LCD) components or may have an array of pixels based on other display technologies. A cross-sectional side view of display 14 is shown in FIG. 2.

As shown in FIG. 2, display 14 may include a pixel array such as pixel array 24. Pixel array 24 may include an array of pixels such as pixels 16 of FIG. 1 (e.g., an array of pixels having rows and columns of pixels 26). Pixel array 24 may be formed from a liquid crystal display module (sometimes referred to as a liquid crystal display or liquid crystal layers) or other suitable pixel array structures. A liquid crystal display for forming pixel array 24 may, as an example, include upper and lower polarizers, a color filter layer and a thin-film transistor layer interposed between the upper and lower polarizers, and a layer of liquid crystal material interposed between the color filter layer and the thin-film transistor layer. Liquid crystal display structures of other types may be used in forming pixel array 24, if desired.

During operation of 14, images may be displayed on pixel array 24. Backlight 42 (which may sometimes be referred to as a backlight, backlight layers, backlight structures, a backlight module, a backlight unit, etc.) may be used in producing backlight illumination 44 that passes through pixel array 24. This illuminates any images on pixel array 24 for viewing by a viewer such as viewer 20 who is viewing display 14 in direction 22.

Backlight unit 42 may have optical films 26, a light diffuser such as light diffuser (light diffuser layer) 34, and light-emitting diode array 36. Light-emitting diode array 36 may contain a two-dimensional array of light-emitting diodes 38 that produce backlight illumination 44. Light-emitting diodes 38 may, as an example, be arranged in rows and columns and may lie in the X-Y plane of FIG. 2.

Light-emitting diodes 38 may be controlled in unison by control circuitry in device 10 or may be individually controlled (e.g., to implement a local dimming scheme that helps improve the dynamic range of images displayed on pixel array 24). The light produced by each light-emitting diode 38 may travel upwardly along dimension Z through light diffuser 34 and optical films 26 before passing through pixel array 24. Light diffuser 34 may contain light-scattering structures that diffuse the light from light-emitting diode array 36 and thereby help provide uniform backlight illumination 44. Optical films 26 may include films such as dichroic filter 32, phosphor layer 30, and films 28. Films 28 may include brightness enhancement films that help to collimate light 44 and thereby enhance the brightness of display 14 for user 20 and/or other optical films (e.g., compensation films, etc.).

Light-emitting diodes 38 may emit light of any suitable color. With one illustrative configuration, light-emitting diodes 38 emit blue light. Dichroic filter layer 32 may be configured to pass blue light from light-emitting diodes 38 while reflecting light at other colors. Blue light from light-emitting diodes 38 may be converted into white light by a photoluminescent material such as phosphor layer 30 (e.g., a layer of white phosphor material or other photoluminescent material that converts blue light into white light). White light that is emitted from layer 30 in the downwards (−Z) direction may be reflected back up through pixel array 24 as backlight illumination by dichroic filter layer 32 (i.e., layer 32 may help reflect backlight outwardly away from array 36). By placing the photoluminescent material of backlight 42 (e.g., the material of layer 30) above diffuser layer 34, light-emitting diodes 38 may be configured to emit more light towards the edges of the light-emitting diode cells (tiles) of array 36 than at the centers of these cells, thereby helping enhance backlight illumination uniformity.

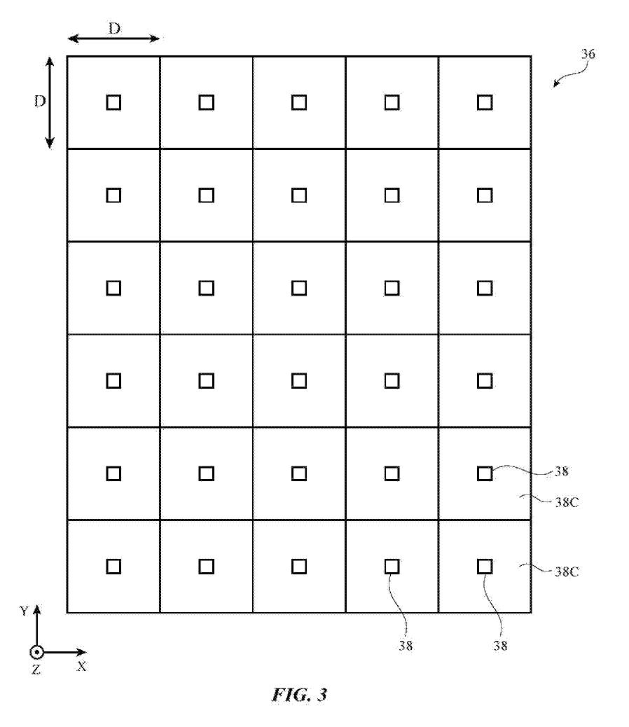

FIG. 3 is a top view of an illustrative light-emitting diode array for backlight 42. As shown in FIG. 3, light-emitting diode array 36 may contain row and columns of light-emitting diodes 38. Each light-emitting diode 38 may be associated with a respective cell (tile area) 38C. The length D of the edges of cells 38C may be 2 mm, 18 mm, 1-10 mm, 1-4 mm, 10-30 mm, more than 5 mm, more than 10 mm, more than 15 mm, more than 20 mm, less than 25 mm, less than 20 mm, less than 15 mm, less than 10 mm, or other suitable size. If desired, hexagonally tiled arrays and arrays with light-emitting diodes 38 that are organized in other suitable array patterns may be used. The configuration of FIG. 3 in which light-emitting diode array 36 has rows and columns of rectangular (e.g., square) light-emitting diode regions such as cells 38C is merely illustrative.

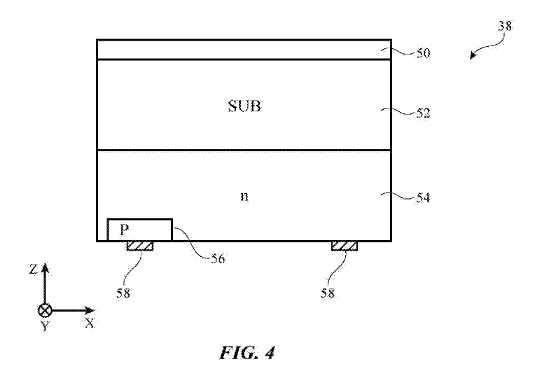

FIG. 4 is a cross-sectional side view of illustrative light-emitting diode. Light-emitting diodes such as light-emitting diode 38 of FIG. 4 may have terminals such as contacts 58. Contacts 58 may be soldered to a printed circuit or other substrate (e.g., so that light-emitting diodes 38 may be mounted in an array such as array 36 of FIG. 3). Light-emitting diode 38 may have n-type region 54 and p-type region 56. Regions 54 and 56 may be formed on substrate 52 from a crystalline semiconductor material such as gallium nitride. Substrate 52 may be formed from a transparent crystalline material such as sapphire or other suitable substrate material. Reflector layer 50 (e.g., a distributed Bragg reflector) may be formed on substrate 52 to help direct emitted light from diode 38 sideways.

FIG. 5 is a cross-sectional side view of an illustrative light-emitting diode cell. As shown in FIG. 5, each light-emitting diode cell (tile) 38C in light-emitting diode array 36 may have a reflector such as cavity reflector 68. Reflector 68 may have a square outline (i.e., a square footprint when viewed from above) or may have other suitable shapes and may be formed from sheet metal (e.g., stamped sheet metal), metallized polymer film, a thin-film metal on a plastic carrier, a dielectric thin-film stack that forms a dielectric mirror on a polymer film or molded plastic carrier, or other suitable reflector structure. Light-emitting diode 38 may be soldered or otherwise mounted to metal traces in printed circuit 60. An opening in the center of reflector 68 may receive light-emitting diode 38. A transparent structure such as transparent dome structure 70 may be formed over light-emitting diode 38. Dome structure 70 may be formed from a bead of clear silicone or other transparent polymer (as an example). During operation, light-emitting diode 38 emits light that is refracted outwardly (away from the Z axis) by dome structure 70 as shown by emitted light ray 62 and refracted light ray 64. Rays of light such as ray 64 may then be reflected upwardly (in the Z direction) off of the surface of the curved walls of cavity reflector 68 (see, e.g., illustrative reflected light ray 66), thereby producing backlight illumination 44.

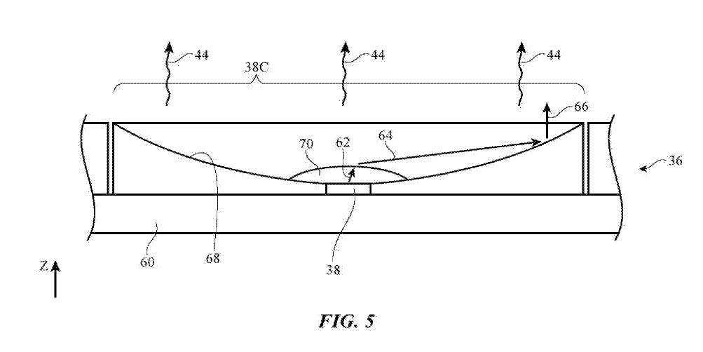

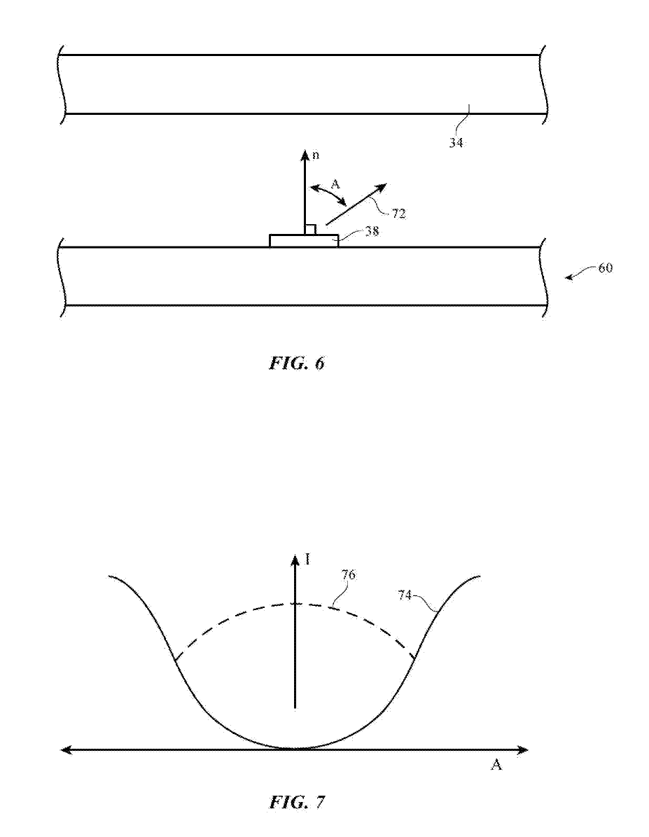

As shown in FIG. 6, emitted light rays from light-emitting diode 38 such as ray 72, may be characterized by an angle A with respect to surface normal n of light-emitting diode 38. Light 72 that is traveling parallel to the Z dimension is parallel to surface normal n (angle A=0°). Light 72 that is traveling parallel to the X-Y plane is traveling perpendicular to the Z dimension and surface normal n (i.e., A=90°). Light 72 that is traveling at other orientations relative to surface normal n is characterized by an intermediate value of angle A.

If light-emitting diode 38 were to include a white phosphor, light-emitting diode 38 might emit light with a Lambertian intensity profile as illustrated by Lambertian curve 76 of FIG. 7. This type of light intensity profile is characterized with a concentration of light about dimension Z (A=0°) and has a tendency to generate hotspots (areas of enhanced light output intensity) aligned with the centers of the light-emitting diode cells. This could lead to dark regions at the borders between adjacent cells.

Ideally, emitted light from light-emitting diodes would have an angular profile such as profile 74 of FIG. 7 (e.g., a profile that varies as a function of cos(A)⁻³). In practice, the intensity of light emitted from diodes 38 differs somewhat from the ideal angular profile of curve 74. As a result, there is still a risk that hotspots will develop directly above diodes 38 (i.e., in the centers of cells 38C). This could create undesirable visible artifacts in backlight illumination 44 (e.g., dark borders between cells 38C, etc.).

To help ensure that backlight 44 is uniform, light diffuser 34 and/or other structures in backlight 42 may be provided with patterned ink, patterns of reflecting protrusions, angularly-dependent thin-film interference filters, and/or other light reflecting and light scattering structures that help reflect on-axis emitted light at the center of cells 38C back towards diodes 38 while allowing light (e.g., obliquely angled light) at the edges of cells 38C to be passed upwardly towards films 26. This helps reduce hotspots in the middle of cells 38C and smooths out light intensity variations that might otherwise arise as light from array 36 is diffused by light diffuser 34.

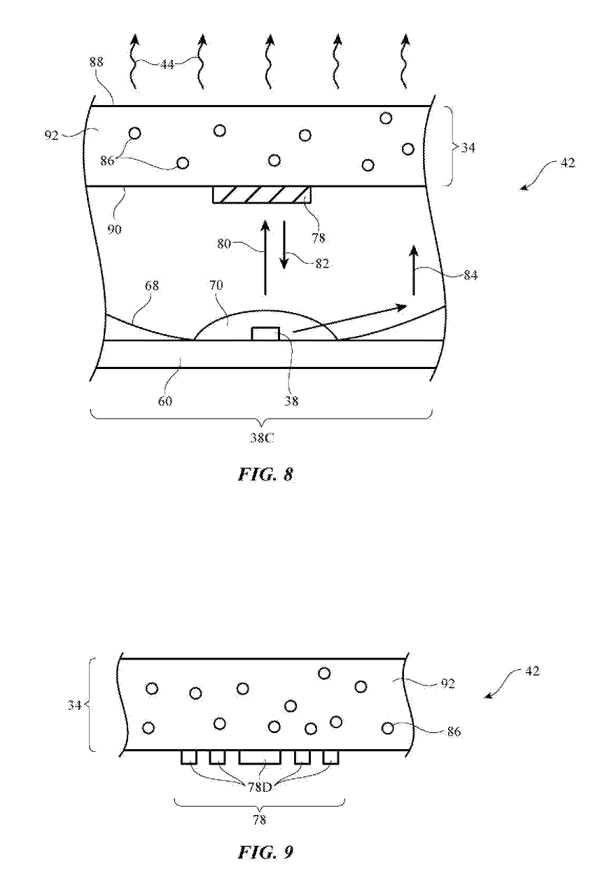

Consider, as an example, the scenario of FIG. 8. As shown in FIG. 8, light diffuser 34 may be formed from a layer of transparent material such as such as transparent layer 92. Transparent layer 92 may be formed from a material such as glass, polymer (e.g., polystyrene, polycarbonate, acrylic, etc.), ceramic, or other suitable material, Transparent layer 92 may have a planar shape with a thickness of 0.05 to 2 mm, more than 0.1 mm, more than 0.2 mm, more than 0.5 mm, less than 1.5 mm, less than 1 mm, less than 0.5 mm, or other suitable thickness. Transparent layer 92 in light diffuser 34 may have opposing upper and lower surfaces such as upper surface 88 (facing pixel array 24) and opposing lower surface 90 (facing array 36).

To help homogenize backlight illumination 44 being emitted by backlight 42, backlight 42 may be provided with light homogenizing structures such as structures 78. In the example of FIG. 8, structures 78 are formed from a patterned coating of white ink or other reflective material on lower surface 90 of light diffuser 34. If desired, light homogenizing structures for backlight 42 may be embedded within material 92, may be formed on upper surface 88, may be formed from one or more layers of material that are separate from light diffuser 34, and/or may be formed from other suitable structures in backlight 42.

Structures 78 may be formed from opaque light reflecting material (e.g., metal or a dielectric stack that forms a dielectric mirror), and/or may be formed from material that is at least somewhat transparent (e.g., translucent material such as white ink). Translucent materials such as white ink may be formed from polymer that includes light-scattering particles (e.g., particles of titanium dioxide, etc.) and may help diffuse and scatter light as well as reflecting light in the center of cells 38C back towards diodes 38. Structures 78 may be patterned by depositing blanket coating layer(s) and patterning the coating using photolithography, by depositing white ink or other material using inkjet printing, screen printing, pad printing, spraying through a shadow mask, or, by using other suitable patterning techniques. In sonic configurations, light homogenizing structures for backlight 42 may be formed by creating recesses and/or protrusions in diffuser 34 (e.g., pyramidal or conical recesses filled with polymer of a different index of refraction, etc.).

With one illustrative configuration, structures 78 of FIG. 8 may be formed by printing an array of pads (dots) of white ink (e.g., circular pads, square pads, dots of other shapes, etc.) on lower surface 90. Each white ink pad may be aligned with a respective light-emitting diode 38 (as shown in FIG. 8) or there may be multiple pads for each diode 38.

During operation, at least some of the light from light-emitting diode 38 that is emitted directly upwards in the center of cell 38C (e.g., light 80 of FIG. 8) will be reflected downwards, as shown by reflected light 82. Reflected light 82 will be spread out laterally (e.g., by reflecting from cavity reflector 68). Other light, such as light 84 that is emitted from light-emitting diode 38 sideways, may reflect off of cavity reflector 68 without reflecting off of structure 78 and will pass upwards through diffuser 34 to serve as backlight 44. By recycling light near the center of each cell 38C while allowing light near the edges of each cell 38C to pass directly through diffuser 34, the intensity of light near the edges of each cell 38C may be increased relative to the intensity of light near the center of each cell 38C. This helps ensure that backlight 44 will be uniform across the surface of light diffuser 34 and backlight 42. If desired, light-scattering particles 86 (e.g., microbeads, hollow microspheres, bubbles, and/or other light-scattering particles) may be embedded within material 92 to further diffuse emitted light. Light-scattering particles 86 may have an index of refraction that differs from that of material 92. For example, the refractive index of particles 86 may be larger than the refractive index of material 92 or may be lower than the refractive index of material 92.

In the illustrative configuration of FIG. 8, a single structure 78 (e.g., a single pad) has been provided above the light-emitting diode 38 in each cell 38. If desired, a cluster of pads (circular pads, square pads, or pads of other shapes) may be formed above each light-emitting diode, as illustrated by the cluster of pads 78D forming structure 78 in FIG. 9. If desired, the density of pads 78D in each cluster (e.g., the number of pads per unit area and/or the area consumed by the pads per unit area) may be varied as a function of position. For example, each pad cluster may have more pads and/or larger pads near the center of that pad cluster than near the edges of that pad cluster. The use of graded structures such as pad clusters with graded pad densities (e.g., pads concentrated over diodes 38) may help smoothly reduce hotspots in cells 38C.

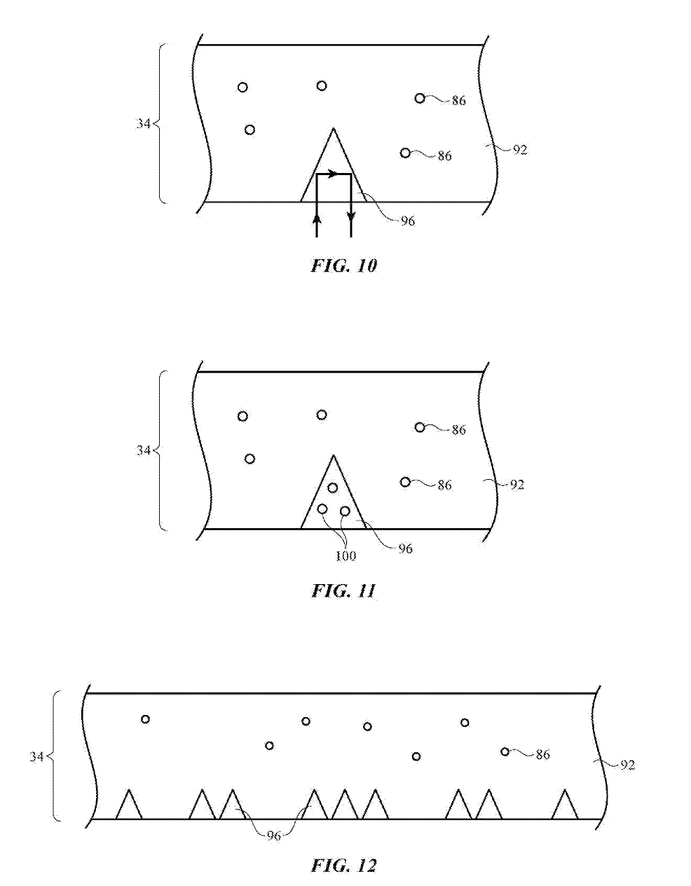

FIG. 10 shows how recesses such as recess 96 may be formed on lower surface 90. Recesses 96 may each be aligned with a respective light-emitting diode (e.g., each recess 96 may be aligned with the center of a respective cell 38C) or multiple recesses 96 may overlap each cell 38C. Recesses 96 may be filled with a filler material that has an index of refraction that is different than the index of refraction of material 92 of light diffuser 34. For example, recesses 96 may be filled with a polymer, inorganic material, or other material that has a refractive index that is greater than the refractive index of material 92 to promote downwards light reflection of rays such as illustrative light ray 98 due to total internal reflection. Particles 86 may have a refractive index that is different than (e.g., lower than) the refractive index of material 92 to promote light scattering as light passes through diffuser 34. Recesses 96 may have the shape of pyramids, grooves, cones, pits with curved sidewall profiles, and/or other suitable shapes. These shapes may help reflect on-axis light (e.g., light traveling directly upwards from diodes 38 at the centers of cells 38C) while allowing off-axis light (e.g., light reaching the edge of cells 38C at oblique angles) to pass. Recesses 96 may also be placed directly above light-emitting diodes 38 to help reduce hotspots in the center of cells 38C.

As shown in FIG. 11, particles 100 may be included in the material that fills recesses 96. Particles 100 may be, for example, silver microspheres that enhance reflectivity for light from light-emitting diodes 38 or may be other reflectivity enhancement particles. Using pyramidal or conical structures such as illustrative recesses 96 of FIGS. 10 and 11, on-axis light of the type that is emitted directly upwards from light-emitting diodes 38 in the center of cells 38C can be recycled whereas off-axis light may escape and pass through diffuser 34, thereby helping to homogenize light 44. The concentration of pyramidal or conical reflectors or other reflecting structures such as recesses 96 of FIGS. 10 and 11 may also, if desired, be larger in the portions of cell 38C directly above light-emitting diodes 38 than at the edges of each cell 38C. As shown in FIG. 12, for example, the concentration of recesses 96 may be varied gradually from a high density near the center of cell 38C to a low density near the edge of cell 38C. Recesses 96 may also be arranged so that a single recess 96 overlaps each diode 38 or so that recesses 96 are uniformly distributed across surface 90 of diffuser 34 (and so that there are equal densities of recesses 96 over the centers of cells 38C and over the edges of cells 38C).

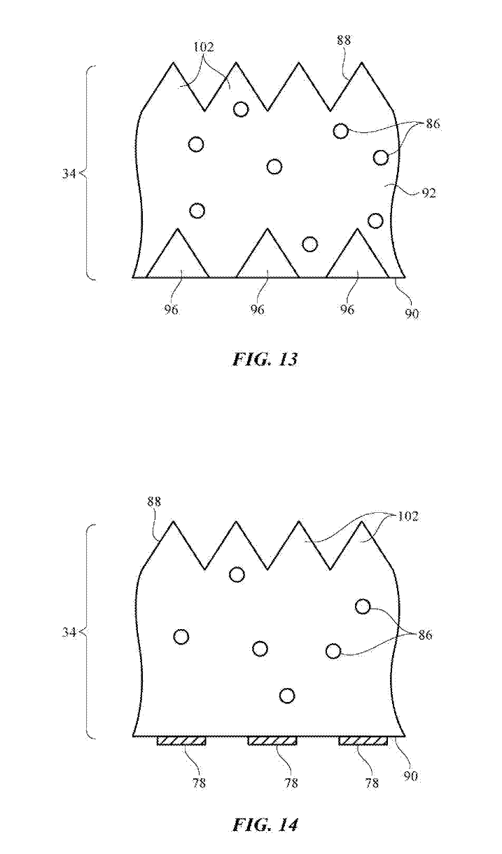

FIG. 13 shows how protrusions such as protrusions 102 may be formed on upper surface 88 of material 92 in light-diffuser 34. Recesses 96 may be formed in lower surface 90 and may be filled with high index of refraction material, as described in connection with FIG. 10. The presence of protrusions 102 may help further diffuse light emitted from array 36 and thereby homogenize backlight illumination 44. Protrusions 102 may be ridges, bumps, pyramidal protrusions, conical protrusions, and/or other light-scattering protrusions.

If desired, protrusions 102 may be formed on upper surface 88 of layer 92 in a light diffuser having printed white ink light-diffusing structures (pads) such as light homogenizing structures 78 of light diffuser 34 of FIG. 14. Protrusions 102, recesses 96, and/or light homogenizing structures such as printed white ink structures 78 of FIG. 14 may be provided in uniform patterns (e.g., arrays of rows and columns or uniformly dispersed random patterns) across surfaces 88 and/or 90 or may be graded in density (e.g., so that enhanced concentrations of light homogenizing structures are located above respective diodes 38), or a single light-homogenizing structure (a single ink pad, a single light-reflecting recess filled with high refractive index material, etc.) may be formed above each respective light-emitting diode 38.

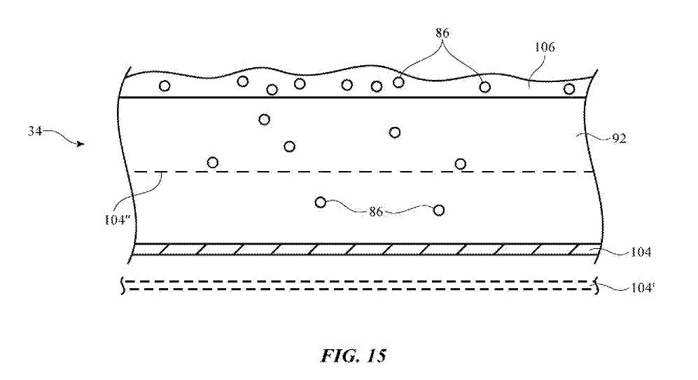

In the illustrative configuration of FIG. 15, light diffuser 34 has a partially reflective film (e.g., a thin metal layer, a stack of dielectric thin-film layers, etc.) such as partially reflective film 104. Film 104 may be formed on the lower surface of layer 92, may be embedded in layer 92 (see, e.g., illustrative embedded film location 104″), and/or may be separate from layer 92 (see, e.g., illustrative film location 104′). Light that is reflected downwardly from film 104 may be reflected back in the upwards direction by cavity reflector 68. The presence of film 104 thereby helps to enhance the number or reflections for each light ray and therefore enhances the homogenization of emitted light from light-emitting diodes array 36 before this light passes through all of layer 92. If desired, additional diffusion may he provided by diffusive coating 106. Coating 106 may be formed from a polymer layer on the upper surface of diffuser 34 with embedded light-scattering particles 86.

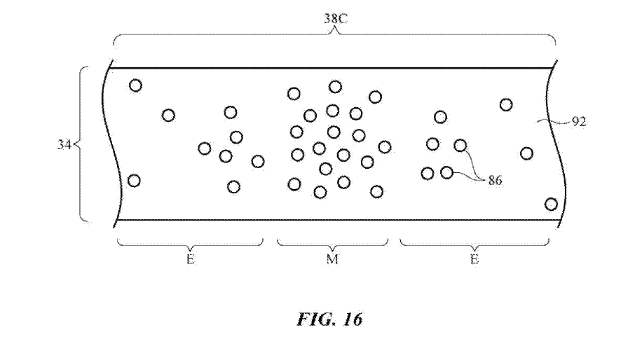

FIG. 16 shows how the density (concentration) of light-scattering particles 86 (e.g., the number of particles 86 per unit area of diffuser 34) may be graded. For example, the density of light-scattering particles 86 may be greater in the center M of each cell 38C than at the edges E of each cell 38C. This variation in the density of light-scattering particles 86 as a function of lateral distance across diffuser 34 may help increase scattering near the center M and thereby reduce hotspots for light 44. Particles 86 may be concentrated as shown in FIG. 16 in light diffusers 34 with patterned white ink pads, reflective recesses, and/or other light homogenizing structures.

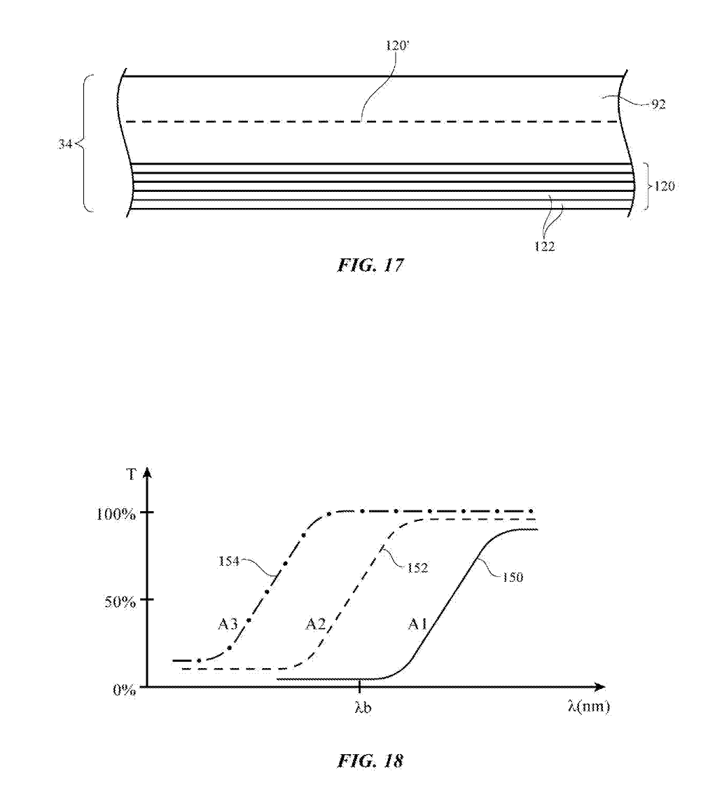

FIG. 17 is a cross-sectional side view of light diffuser 34 in an illustrative configuration in which light diffuser 34 has been provided with an interference filter 120 formed from a stack of thin-film dielectric layers 122. Layers 122 may be, for example, inorganic layers of differing refractive indices (e.g., alternating high and low index-of-refraction layers formed from materials such as aluminum oxide, silicon oxide, silicon nitride, titanium oxide, other metal oxides, nitrides, and/or oxynitrides, etc.). Filter 120 may be formed on the surface of layer 92 (e.g., on the lower surface) or may be embedded in material 92 (see, e.g., location 120′).

Layers 122 may be configured so that filter 120 blocks shorter wavelength light and passes longer wavelength light. The transmission spectrum of the filter may vary as a function of angle of incidence. This causes the transmission of light at a given wavelength such as wavelength λb of FIG. 18, which may be associated with the blue light emitted from diode 38, to vary depending on the angle-of-incidence of that light with respect to filter 120.

As shown in FIG. 18, filter 120 may exhibit transmission spectrum 150 when exposed to light from diode 38 at angle A1 (e.g., close to 0° and parallel to surface normal n of FIG. 6). Filter 120 may exhibit transmission spectrum 152 for light that is traveling at angles near angle A2 (e.g., 45°). At larger angles (e.g., angles A3 above 60°), filter 120 may be characterized by transmission spectrum 154. Due to the variation in the transmission spectrum of filter 120 as a function of angle of incidence, blue light at λb will be reflected (e.g., transmission T will be close to 0%) when characterized by an angle-of-incidence of A1, will be partly reflected and partly transmitted (e.g., transmission T will be close to 50%) when characterized by an angle-of-incidence of A2 that is greater than A1, and will be transmitted (e.g., transmission T will be close to 100%) when characterized by an angle-of-incidence of A3 that is greater than A2. As the curves of FIG. 18 demonstrate, blue light emitted from light-emitting diodes 38 will be reflected and therefore recycled effectively when emitted directly upwards (parallel to surface normal n), but will be allowed to pass when characterized by more oblique angles. This may help reduce hotspots for emitted light in the centers of cells 38C.

The foregoing is merely illustrative and various modifications can be made by those skilled in the art without departing from the scope and spirit of the described embodiments. The foregoing embodiments may be implemented individually or in any combination.

What is claimed is:

1. A display, comprising:
an array of pixels; and
a backlight configured to produce backlight illumination for the array of pixels, wherein the backlight comprises:
a two-dimensional array of light-emitting diodes that are configured to emit blue light and that are arranged in a two-dimensional array of respective light-emitting diode cells; and
a light diffuser layer interposed between the array of light-emitting diodes and the array of pixels, wherein the light diffuser layer has a thin-film interference filter formed from a stack of thin-film dielectric layers, wherein the thin-film interference filter is characterized by a transmission spectrum that varies as a function of angle-of-incidence for the blue light and transmits more blue light at a first angle-of-incidence than blue light at a second-angle-of-incidence and wherein the first angle-of-incidence is greater than the second angle-of-incidence.

2. The display defined in claim 1 wherein the backlight further comprises a photoluminescent layer that is interposed between the light diffuser layer and the array of pixels and that is configured to convert the blue light to white light.

3. The display defined in claim 2 wherein the backlight further comprises a dichroic filter layer that is configured to reflect the white light through the array of pixels.

4. The display defined in claim 3 wherein the backlight further comprises a cavity reflector in each light-emitting diode cell that is configured to reflect the blue light emitted by the light-emitting diode of that light-emitting diode cell towards the thin-film interference filter.

5. The display defined in claim 4 wherein the thin-film interference filter is configured to reflect light at a first wavelength at a 0° angle-of-incidence and is configured to pass light at a second wavelength that is longer than the first wavelength at the 0° angle-of-incidence.

6. A display, comprising:
an array of pixels; and
a backlight configured to produce backlight illumination for the array of pixels, wherein the backlight comprises:
an array of light-emitting diodes arranged in an array of respective light-emitting diode cells;
a cavity reflector in each light-emitting diode cell that is configured to reflect blue light emitted by the light-emitting diode of that light-emitting diode cell;
a layer interposed between the array of light-emitting diodes and the array of pixels, wherein the layer has a patterned structure facing the array of light-emitting diodes that reduces hotspots in the blue light; and
optical films interposed between the layer and the array of pixels, wherein the optical films include a photoluminescent layer that is configured to convert the blue light to white light and include a dichroic filter layer that is configured to reflect the white light through the array of pixels.

7. The display defined in claim 6 wherein the patterned structure comprises a patterned white ink coating that includes pads and wherein a single one of the pads is aligned with each of the light-emitting diodes.

8. The display defined in claim 6 wherein the patterned structure comprises a patterned white ink coating that includes a cluster of pads associated with each light-emitting diode cell and wherein the cluster of pads associated with each light-emitting diode cell has a pad density that varies across that light-emitting diode cell.

9. The display defined in claim 8 wherein each light-emitting diode cell has a center and has edges, wherein the light-emitting diode of each light-emitting diode cell is located at the center, and wherein the pad density in each light-emitting diode cell is larger at the center of that cell than at the edges of that cell.

10. The display defined in claim 6 wherein the patterned structure comprises structures on the layer that form a patterned light-scattering surface.

11. The display defined in claim 10 further comprising:
light-scattering particles in the layer that are concentrated at the centers of the light-emitting diode cells, wherein the patterned light-scattering surface is formed from light-scattering protrusions on the layer.

12. The display defined in claim 6 wherein the patterned structure is a patterned metal coating.

13. The display defined in claim 6 wherein the patterned structure is a patterned dielectric mirror coating.

14. A display, comprising:
an array of pixels; and
a backlight configured to produce backlight illumination for the array of pixels, wherein the backlight comprises:
an array of light-emitting diodes that are configured to emit blue light and that are arranged in an array of respective light-emitting diode cells; and
a light diffuser layer interposed between the array of light-emitting diodes and the array of pixels, wherein the light diffuser layer has a transparent layer of a first refractive index with a first surface that faces the array of pixels and an opposing second surface facing the array of light-emitting diodes and wherein the light diffuser layer has recesses in the second surface that are filled with a filler material having a second refractive index that is greater than the first refractive index.

15. The display defined in claim 14 further comprising reflectivity enhancement particles in the filler material.

16. The display defined in claim 14 wherein the recesses comprise recesses selected from the group consisting of: pyramidal recesses and conical recesses.

17. The display defined in claim 14 further comprising light-scattering particles embedded in the transparent layer, wherein the light-scattering particles have a third refractive index that is less than the first refractive index.

18. The display defined in claim 17 wherein each light-emitting diode cell has a center and edges and wherein the light-scattering particles are concentrated over the centers of the light-emitting diode cells.

19. The display defined in claim 14 further comprising light-scattering protrusions on the first surface of the transparent layer.

20. The display defined in claim 14 further comprising:
a photoluminescent layer that is configured to convert the blue light to white light; and
a dichroic filter layer that is configured to reflect the white light through the array of pixels.
